(19) United States
(12) Patent Application Publication
(10) Pub. No.: US 2022/0277344 A1
(43) Pub. Date: Sep. 1, 2022

(54) ADVERTISING METHOD AND ELECTRONIC DEVICE USING THE SAME

(71) Applicant: Fulian Precision Electronics (Tianjin) Co., LTD., TIANJIN (CN)

(72) Inventors: PO-CHENG CHEN, New Taipei (TW); YU-TE LEE, New Taipei (TW); YU-WEN CHEN, New Taipei (TW)

(21) Appl. No.: 17/679,636

(22) Filed: Feb. 24, 2022

(30) Foreign Application Priority Data
Feb. 26, 2021 (CN) 202110221129.5

(51) Int. Cl. G06Q 30/02; G06F 40/279

(52) U.S. Cl. CPC G06Q 30/0251; G06Q 30/0276; G06F 40/279; G06Q 50/01

(57) ABSTRACT

A targeted advertising method used in an electronic device targets and obtains a user posting on a social platform, wherein the target posting includes image information and text information. A first analysis of the image information, and a second analysis of the text information are carried out. The electronic device further generates an advertising message corresponding to the tone and emotional content as extracted by an AI process carried out in relation to the words used in and extracted from the target posting according to the results of the first and/or second analysis and publishes the advertising message at a relevant position in the target posting.

### CROSS-REFERENCE TO RELATED APPLICATIONS

This application claims priority to Chinese Patent Application No. 202110221129.5 filed on Feb. 26, 2021, in China State Intellectual Property Administration, the contents of which are incorporated by reference herein.

### FIELD

The subject matter herein generally relates to a field of artificial intelligence technology, and especially relates to an advertising method and an electronic device.

### BACKGROUND

With a rapid development of social networks, advertising in social networks has increased sharply. There are two main ways for advertisers to advertise on the network platform. One is mild passive advertising, and the other is aggressive passive advertising. The mild passive advertisement means that the advertiser only places advertisements on a specific position of a specific web page. The aggressive passive advertisement refers to jumping out of a small window to force the user to browse or click the advertisement before the user reads the text of the web page or watches the film. These two traditional advertising methods have certain marketing effects. However, due to strong sensory aggression of these two traditional advertising methods, consumers may be repulsed by the advertisements, making these two traditional advertising methods likely to be ignored or blocked by the consumers. In addition, the traditional advertising methods also include direct publishing to the audience by an advertising platform. This traditional advertising method does not advertise to different types of audience groups according to the content of advertisements, thus most of the advertisements are not received by an audience who might need and be interested in the advertised goods.

### BRIEF DESCRIPTION OF THE DRAWINGS

Implementations of the present disclosure will now be described, by way of embodiment, with reference to the attached figures.

FIG. 1 is a schematic diagram of one embodiment of an electronic device according to the present disclosure

FIG. 2 is a flowchart of one embodiment of an advertising method according to the present disclosure.

FIG. 3 is a block diagram of one embodiment of an advertising system according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. In addition, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

An advertising method is illustrated in the disclosure, the method is applied in one or more electronic devices. The electronic device can automatically perform numerical calculation and/or information processing according to a number of preset or stored instructions. The hardware of the electronic device includes, but is not limited to, a microprocessor, an Application Specific Integrated Circuit (ASIC), a Field Programmable Gate Array (FPGA), a Digital signal processor (DSP), or an embedded equipment, etc.

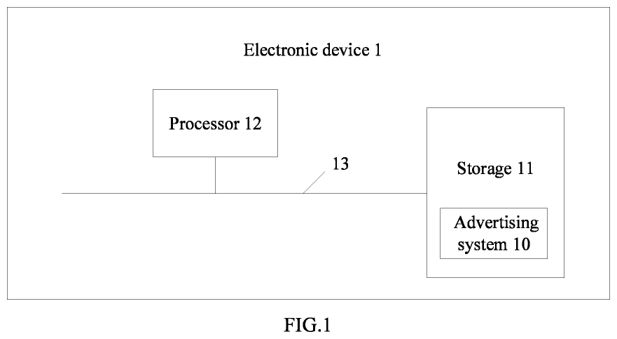

FIG. 1 illustrates the electronic device (electronic device 1). An advertising system 10 is run in the electronic device 1. In one embodiment, the electronic device 1 includes, but is not limited to a storage 11, at least one processor 12 and at least one communication bus 13. The advertising system 10 is stored in the storage 11 and is operable on the at least one processor 12.

The at least one processor 12 implements steps of the advertising method described below when executing the advertising system 10.

In one embodiment, the advertising system 10 may be divided into one or more modules/units, which are stored in the storage 11 and executed by the at least one processor 12 to complete the present application. The one or more modules/units may be a series of computer-readable instruction segments capable of completing specific functions, which are used to describe process of the advertising system 10 in the electronic device 1.

In one embodiment, the electronic device 1 can be a computer, a mobile phone, a tablet computer, a personal digital assistant (PDA) and other devices installed with applications. Those skilled in the art can understand that FIG. 1 is only an example of the electronic device 1 and does not constitute a limitation. Another electronic device 1 can include more or fewer components, or combine some components, or different components than as shown in FIG. 1. For example, the electronic device 1 can also include input devices and output devices, network access devices, buses, etc.

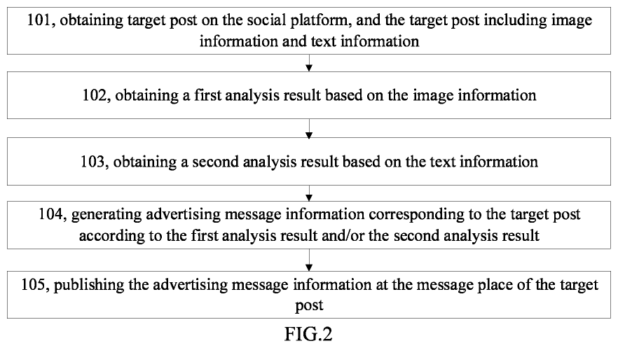

FIG. 2 illustrates the advertising method. The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, obtaining a target post on a social platform, the target post including image information and text information.

In one embodiment, in order to enable advertisements to be received by users who may really need and are interested in same, it is necessary to post messages under postings of potential consumer users, so as to attract the attention of the potential consumer users, so that different advertisements can be put in for different consumer users.

In one embodiment, the target post is a post published by the potential consumer user on a social platform.

In one embodiment, obtaining target post on the social platform includes:

step (1), obtaining all posts on the social platform;

step (2), obtaining advertising contents to be launched;

step (3), extracting key information from the advertisement contents;

step (4), determining whether one post including key information of the advertising contents in all the posts exists, and when the post including the key information in all the posts is found to exist, determining as the target post the post which includes the key information.

In one embodiment, after registering on the social platform, a user will get a unique User Identification (UID). When the user logs in to the social platform by the UID, all posts of the user can be obtained according to the UID. Generally, when posts are posted on the social platform, the user may import pictures and/or input text content with emotional connections. In one embodiment, the social platform can be Facebook®, Microblog®, Twitter®, etc.

In one embodiment, the post includes image information and text information. For example, the image information can be a landscape map, and the text information can be text content input by the user when publishing the landscape map on the social platform. In one embodiment, the advertising method further includes screening all posts according to publication time of the posts. For example, the posts published by users in last 30 days can be screened without considering the posts at other times.

In one embodiment, after taking a car as the key information of the advertising contents, all the posts are traversed to search posts which contain the car, and the posts containing the car are taken as the target stickers. In all the posts, if there is no post which includes the key information, the method returns to step (1) and repeats steps (1)-(4) to search for the or a target post.

In one embodiment, by screening the target post from all posts published on the social platform and taking users making the target posts as objects of advertising, the method can determine potential consumer users and advertise to the potential consumer users to achieve the purpose of accurate and targeted advertising.

As a plurality of target posts related to the advertising contents may appear in all posts published by the social platform, the users creating the target post may also be different. Therefore, it is necessary to establish a relationship table between the target post and user information. In one embodiment, before block 101, the method further includes:

Generating a target post listing based on the target post, the target post listing including target posts and user UIDs corresponding to different target posts. For example, one or more target posts may correspond to a first user UID, or another one or more target posts may correspond to a second user UID.

At block 102, obtaining a first analysis based on the image information.

In one embodiment, in order to have meaningful interaction with the target post, it is necessary to understand specific content of the target post. In one embodiment, the first analysis related to the target post is obtained by analyzing the image information. In one embodiment, the first analysis considers a target content of the image information and a text description of the target content.

In one embodiment, the target post is sequentially extracted from the target post listing, and the image information is extracted from the target post.

In one embodiment, firstly, the image is input to a pre-trained Convolutional Neural Network (CNN) for feature extraction and the image feature (i.e. the target content of the image information) to be obtained, and the image feature is taken in the first analysis. Then, the image features are input into a pre-trained Recurrent Neural Network (RNN), the text description of the target content in the image is obtained based on an image description algorithm, and the text description is taken in the first analysis. In one embodiment, the CNN and RNN can be selected according to actual needs of users. For example, an image with a car is input into a VGGNet model to obtain the image features, and then the obtained image features are input into a simple RNN model based on the image description algorithm to obtain the text description “a red car is parked on the roadside”.

By analyzing the image information of the target post, the orientation of a user's interest can be preliminarily obtained. For example, in the above example, it can be seen that the user may be interested in cars.

At block 103, obtaining a second analysis based on the text information.

In order to better understand the content that the user wants to express, it is necessary to analyze the text information of the target post.

In one embodiment, firstly, the key information of the text information is extracted by using a keyword extraction algorithm, and then the emotion-based information of the text information is obtained by using the text emotion analysis algorithm. In one embodiment, the emotion-based information is the user's apparent emotion as reflected by the target post. The key information and the emotional information are taken for the second analysis.

In one embodiment, the keyword extraction algorithm and the text emotion analysis algorithm can be selected according to the actual needs of users. For example, the keyword extraction algorithm “Yet Another Keyword Extractor” can be used to extract the keyword of the text “terrible, the car broke down on the way” is “terrible, car, broke down”. The text “terrible, the car has broken down again” is analyzed by using the text emotion analysis algorithm “gradable lexicon-based” and the result of analysis produces “unhappy”.

At block 104, generating advertising message information corresponding to the target post according to the first analysis result and/or the second analysis result.

It should be noted that, immediate and thoughtless advertising arouses disgust of consumers, which is likely to be ignored or blocked by consumers. The present application is not to directly push product information to be sold at a message position where potential consumers post messages, but to provide meaningful feedback on the message at a position in the message which is in accordance with the content of each message, so as to arouse the curiosity of potential consumers about the message makers interaction with them and to achieve an effect of commercial product exposure.

In one embodiment, generating advertising message information corresponding to the target post according to the results of the first and/or second analysis includes:

(1) creating a corpus in advance, the corpus including a number of first vocabulary groups and text replies corresponding to each of a number of first vocabulary groups, wherein the first vocabulary group includes a number of words, for example, taking “car, broken down, unhappy” as the first vocabulary group, the text reply corresponding to the first vocabulary group can be “change to a better car and change to a better mood”;

(2) word segmentation processing being performed on the first analysis result and/or the second analysis result, and obtaining a number of words, and taking the number of words as a second word group;

(3) searching a first target vocabulary group most similar to the second vocabulary group in the corpus.

In one embodiment, a first word frequency vector corresponding to the first word group is constructed based on any first word group and the second word group in the corpus, and a number of first word frequency vectors are obtained. A number of second word frequency vectors corresponding to the second word group are constructed based on the first word group and the second word group. Cosine values between the number of the first word frequency vectors and the number of the second word frequency vectors are calculated according to a cosine value calculation formula and a number of cosine values are obtained, the first vocabulary group corresponding to the largest cosine value among the number of the cosine values is set as the target vocabulary group. In one embodiment, the cosine value calculation formula is

$$cos θ = \frac{{\sum }_{i = 1}^{n} ( Al \times Bl )}{\sqrt{{\sum }_{i = 1}^{n} ( {Al}^{2} ) \times \sqrt{{\sum }_{i = 1}^{n} ( {Bi}^{2} )}}} , \qquad ( formula ( 1 ) )$$

where Aᵢ is the first word frequency vector and Bᵢ is the second word frequency vector. In one embodiment, the first vocabulary group corresponding to the largest cosine value among the number of cosine values is taken as the target vocabulary group.

For example, assuming that the second vocabulary group is “really bad, car, broken down, unhappy”, and the two groups of words in the first vocabulary group are “car, broken down, unhappy” and “bought, new, car, happy”. Firstly, the first word frequency vector corresponding to the first word group is constructed as A1 (0,1,1,1,1), and the second word frequency vector corresponding to the second word group is constructed as B1 (1,1,1,1,1) based on the first word group as “car, broken down, unhappy” and the second word group being “really bad, car, broken down, unhappy”. A1 and B1 are brought into the formula (1) to obtain a cosine value of 0.89 corresponding to the first vocabulary group “car, broken down, unhappy”. Then, the first word frequency vector corresponding to the first vocabulary group is constructed as A2 (0,1,0,0,0), and the second word frequency vector corresponding to the second vocabulary group is constructed as B2 (1,1,1,1,1) based on the first vocabulary group “bought, new, car, happy”. For the second vocabulary group of “really bad, car, broken down, unhappy”, A2 and B2 are brought into the formula (1) to obtain a value of 0.45 corresponding to the first vocabulary group “bought, new, car, happy”. The method compares the 0.89 with 0.45 and determines that the maximum value is 0.89. That is, the first vocabulary group corresponding to 0.89 is the most similar to the second vocabulary group, so “car, broken down, unhappy” can be taken as the target vocabulary group.

In one embodiment, the method searches the target text reply corresponding to the target vocabulary group in the corpus, and sets the target text reply as the advertising message information. For example, in the above example, “change to a good car and change to a good mood” can be used as the advertising message information.

At block 105, publishing the advertising message information at the message place of the target post.

In one embodiment, in order to attract the attention of users, the advertising message information can be automatically published in the post message, thereby urging potential consumers to pay active attention to product information in turn, so as to achieve the effect of commodity exposure.

In one embodiment, after block 105, the method further includes:

when detecting comment information in the advertising message information, the text emotion analysis is carried out in relation to the comment information. When the text emotion analysis is positive emotion, for example, happy, cheerful, comfortable, the advertising contents can be published at the certain position in the message, at the comment information. When the text emotion analysis is negative emotion, for example, angry, disappointed, no choice, the advertising contents are not published.

In one embodiment, after block 105, the method further includes:

After processing the target post, the target post is put into a preset list and the user UID of the target post is recorded.

As continuous bombing of the same user in a short time will cause user fatigue and disgust, a record of interactions with each user is retained by putting a processed target post into the preset list. A time interval for interactions with the same user can be set, and the target post for the next interaction can be further selected from the target post list according to the preset list and the time interval which is set. For example, the time interval can be set to 24 hours, that is, the method does not interact with any posts of the same user again within 24 hours.

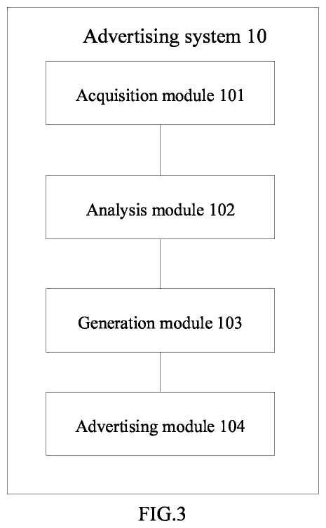

FIG. 3 illustrates the advertising system 10. The advertising system 10 can be divided into one or more modules, and the one or more modules can be stored in the processor 12, and the processor 12 executes the advertising method of the embodiment of the present application. In one embodiment, the one or more modules may be a series of computer program instruction segments capable of completing specific functions, which are used to describe the execution process of the advertising system 10 in the electronic device 1. For example, the advertisement delivery system 10 may be divided into an acquisition module 101, an analysis module 102, a generation module 103, and an advertising module 104 as in FIG. 3.

The acquisition module 101 obtains the target post on the social platform, and the target post includes image information and text information. The analysis module 102 obtains the first analysis result based on the image information and the second analysis result based on the text information. The generation module 103 generates the advertising message information corresponding to the target post according to the first analysis result and/or the second analysis result. The advertising module 104 publishes the advertising message information at the message place of the target post.

In one embodiment, the at least one processor 12 may be a central processing unit (CPU), a general-purpose processor, a digital signal processors (DSP), an application specific integrated circuits (ASIC), a field programmable gate array (FPGA), a programmable logic devices or a transistor logic device, or discrete hardware component, etc. In one embodiment, the processor 12 can be a microprocessor or any conventional processor, etc. The processor 12 is the control center of the electronic device 1, and uses various interfaces and lines to connect various parts of the whole electronic device 1.

In one embodiment, the storage 11 can be used to store the advertising system 10 and/or module units, and the processor 12 realizes various functions of the electronic device 1 by running or executing computer programs and/or modules/units stored in the storage 11 and calling up data stored in the storage 11. The storage 11 can mainly include a storage program area and a storage data area, wherein the storage program area can store an operating system, an application program required for at least one function (such as a sound playback function, an image playback function, etc.); and the storage data area can store data and the like created according to the use of the electronic device 1. In one embodiment, the storage 11 may include nonvolatile/volatile memory, such as hard disk, memory, plug-in hard disk, smart media card (SMC), secure digital (SD) card, flash card, at least one disk storage device, flash device, or other storage device.

The program code is stored in the storage 11, and the at least one processor 12 can call up the program code stored in the storage 11 to perform relevant functions. For example, the modules (acquisition module 101, analysis module 102, generation module 103 and advertising module 104) described in FIG. 3 are program codes stored in the storage 31 and executed by the at least one processor 12, so as to realize the functions of the modules to achieve the purpose of advertising.

It should be noted that if an integrated module/unit of the electronic device 1 is realized in the form of software functional unit and sold or used as an independent product, it can be stored in a computer-readable storage medium. Based on this understanding, the present application realizes all or part of the processes in the methods of the above embodiments, and can also be completed by instructing relevant hardware by a computer program. The computer program can be stored in a computer-readable storage medium. When the computer program is executed by the processor, the steps of the above methods and embodiments are carried out. The computer program code can be in the form of source code, object code, executable file, or some intermediate forms. The computer-readable medium may include any entity or device capable of carrying the computer program code, recording medium, U disk, mobile hard disk, magnetic disk, optical disk, computer memory and read only memory (ROM).

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. An advertising method comprising:
obtaining a target post on a social platform, and the target post comprising image information and text information;
obtaining a first analysis result based on the image information;
obtaining a second analysis result based on the text information;
generating advertising message information corresponding to the target post according to the first analysis result and/or the second analysis result; and
publishing the advertising message information at a message position of the target post.

2. The advertising method as recited in claim 1, further comprising:
obtaining all posts on a social platform;
obtaining advertising contents;
determining the target post from all posts according to the advertising contents.

3. The advertising method as recited in claim 2, further comprising:
extracting key information from the advertisement contents;
determining the post comprising the key information as the target post.

4. The advertising method as recited in claim 1, wherein the first analysis result comprises target contents of the image information and a text description of the target contents.

5. The advertising method as recited in claim 1, further comprising:
extracting key information of the text information by using a keyword extraction algorithm;
extracting emotional information of the text information by using a text emotion analysis algorithm;
determining the second analysis result according to the key information of the text information and the emotional information of the text information.

6. The advertising method as recited in claim 1, further comprising:
creating a corpus, which comprises a plurality of first vocabulary groups and a plurality of text replies corresponding to each of the plurality of first vocabulary groups;
performing a word segmentation processing on the first analysis result and/or the second analysis result, and obtaining a second word group;
searching a target vocabulary group in the corpus, the target vocabulary group having a highest similarity with the second vocabulary group;
searching a target text reply corresponding to the target vocabulary group in the corpus, and setting the target text reply as the advertising message information.

7. The advertising method as recited in claim 6, further comprising:
constructing a first word frequency vector corresponding to the first word group based on any first word group and the second word group in the corpus, and obtaining a plurality of first word frequency vectors;
constructing a plurality of second word frequency vectors corresponding to the second word group based on the first word group and the second word group;
calculating a plurality of cosine values between the plurality of the first word frequency vectors and the plurality of the second word frequency vectors, and obtaining a plurality of cosine values;
setting the first vocabulary group corresponding to the largest cosine value among the plurality of the cosine values to be the target vocabulary group.

8. The advertising method as recited in claim 2, further comprising:
when detecting that any comment information commented on the advertising message information, publishing the advertising contents at the message position of the comment information.

9. An electronic device comprising:
a processor; and
a non-transitory storage medium coupled to the processor and configured to store a plurality of instructions, which cause the processor to:
obtain a target post on a social platform, wherein the target post comprising image information and text information;
obtain a first analysis result based on the image information;
obtain a second analysis result based on the text information;
generate advertising message information corresponding to the target post according to the first analysis result and/or the second analysis result; and
publish the advertising message information at a message position of the target post.

10. The electronic device as recited in claim 9, wherein the plurality of instructions are further configured to cause the processor to:
obtain all posts on the social platform;
obtain advertising contents;
determine the target post from all posts according to the advertising contents.

11. The electronic device as recited in claim 10, wherein the plurality of instructions are further configured to cause the processor to:
extract key information from the advertisement content;
determine the post comprising the key information as the target post.

12. The electronic device as recited in claim 9, wherein the plurality of instructions are further configured to cause the processor to:
extract key information of the text information by using a keyword extraction algorithm;
extract the emotional information of the text information by using a text emotion analysis algorithm;
determine the second analysis result according to the key information of the text information and the emotional information of the text information.

13. The electronic device as recited in claim 9, wherein the plurality of instructions are further configured to cause the processor to:
create a corpus, which comprises a plurality of first vocabulary groups and a plurality of text replies corresponding to each of the plurality of first vocabulary groups;
perform word segmentation processing on the first analysis result and/or the second analysis result, and obtain a second word group;
search a target vocabulary group in the corpus, the target vocabulary group have a highest similarity with the second vocabulary group;
search a target text reply corresponding to the target vocabulary group in the corpus, and set the target text reply as the advertising message information.

14. The electronic device as recited in claim 13, wherein the plurality of instructions are further configured to cause the processor to:
construct a first word frequency vector corresponding to the first word group based on any first word group and the second word group in the corpus, and obtain a plurality of first word frequency vectors;
construct a plurality of second word frequency vectors corresponding to the second word group based on the first word group and the second word group;
calculate a plurality of cosine values between the plurality of the first word frequency vectors and the plurality of the second word frequency vectors, and obtain a plurality of cosine values;
set and the first vocabulary group corresponding to the largest cosine value among the plurality of the cosine values are as the target vocabulary group.

15. The electronic device as recited in claim 10, wherein the plurality of instructions are further configured to cause the processor to:
when detecting that an comment information commented on the advertising message information, publish the advertising content at message position of the comment information.

16. A non-transitory storage medium having stored thereon instructions that, when executed by at least one processor of an electronic device, causes the least one processor to execute instructions of an advertising method, the method comprising:
obtaining a target post on a social platform, and the target post comprising image information and text information;
obtaining a first analysis result based on the image information;
obtaining a second analysis result based on the text information;
generating advertising message information corresponding to the target post according to the first analysis result and/or the second analysis result;
publishing the advertising message information at a message position of the target post.

17. The non-transitory storage medium as recited in claim 16, wherein the advertising method comprising:
obtaining all posts on the social platform;
obtaining advertising contents;
determining the target post from all posts according to the advertising contents.

18. The non-transitory storage medium as recited in claim 16, wherein the advertising method comprising:
extracting key information of the text information by using a keyword extraction algorithm;
extracting the emotional information of the text information by using a text emotion analysis algorithm;
determining the second analysis result according to the key information of the text information and the emotional information of the text information.

19. The non-transitory storage medium as recited in claim 16, wherein the advertising method comprising:
creating a corpus, which comprises a plurality of first vocabulary groups and a plurality of text replies corresponding to each of the plurality of first vocabulary groups;
performing word segmentation processing on the first analysis result and/or the second analysis result, and obtaining a second word group;
searching a target vocabulary group in the corpus, the target vocabulary group having a highest similarity with the second vocabulary group;
searching a target text reply corresponding to the target vocabulary group in the corpus, and setting the target text reply as the advertising message information.

20. The non-transitory storage medium as recited in claim 19, wherein the advertising method comprising:
constructing a first word frequency vector corresponding to the first word group based on any first word group and the second word group in the corpus, and obtaining a plurality of first word frequency vectors;
constructing a plurality of second word frequency vectors corresponding to the second word group based on the first word group and the second word group;
calculating a plurality of cosine values between the plurality of the first word frequency vectors and the plurality of the second word frequency vectors, and obtaining a plurality of cosine values;
setting and the first vocabulary group corresponding to the largest cosine value among the plurality of the cosine values are as the target vocabulary group.
